(19) United States
(12) Patent Application Publication
(10) Pub. No.: US 2018/0082329 A1
(43) Pub. Date: Mar. 22, 2018

(54) EVALUATING PRESENTATION OF CONTENT ITEMS ASSOCIATED WITH VARIOUS OBJECTIVES TO USERS OF AN ONLINE SYSTEM

(71) Applicant: Facebook, Inc., Menlo Park, CA (US)

(72) Inventors: Kyle Edward Johnson, San Francisco, CA (US); Charles David Patterson, San Francisco, CA (US); Mairin Gates Wilson, San Francisco, CA (US)

(21) Appl. No.: 15/268,337

(22) Filed: Sep. 16, 2016

(51) Int. Cl. G06Q 30/02

(52) U.S. Cl. CPC G06Q 30/0247; G06Q 30/0249; G06Q 30/0277; G06Q 30/0275; G06Q 30/0269

(57) ABSTRACT

An online system allows a user to visualize a plan including various campaigns each including one or more content items associated with various objectives. Based on the plan, the online system provides forms or prompts for specifying characteristics, such as bid amounts or budgets, of content items. The online system may generate the plan based on one or more existing campaigns including various content items and characteristics for presenting content items in the existing campaign, allowing the user to identify differences between the plan and content items included in the existing campaigns. When content items included in the plan are included in selection processes by the online system, the online system obtains information describing presentation of content items from various campaigns included in the plan and aggregates the obtained information to provide information describing presentation of content items in the plan.

### BACKGROUND

This disclosure relates generally to presenting content to users of an online system, and more specifically to evaluating presentation of content items to users of the online system.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

In various embodiments, a publishing user provides various campaigns that each include one or more content items for presentation by the online system to users. Providing campaigns allows the publishing user to more easily provide a larger number of content items to the online system for presentation. For example, the publishing user creates campaigns that include content items having different types of content or that include content items associated with different objects. As an example, the online system receives different campaigns that each include content items associated with different products or with different services. While providing campaigns to the online system simplifies the publishing user providing content items to the online system, it may complicate the publishing user later retrieving or evaluating content items. For example, content items having one or more particular characteristics are in different content items, so the publishing user may access multiple campaigns to evaluate presentation of content times having the particular characteristic. This may increase an amount of time for the publishing user to retrieve information about various content items having the particular characteristics, to evaluate presentation of content items having common characteristics but included in different campaigns, or for the publishing user to subsequently provide one or more characteristics of different content items.

### SUMMARY

An online system presents various content items to its users. In various embodiments, the online system obtains content items from a user and includes the content items in one or more selection processes selecting content for presentation to other online system users. A user providing content items to the online system provides a campaign including one or more content items to the online system. The user may provide multiple campaigns including different content items to the online system, with different campaigns including content items identifying different objects or including different types of content for presentation.

The user providing content items to the online system associates an objective with various content items. An objective associated with a content item specifies an interaction the user providing the content item to the online system desires other users to perform when presented with the content item. Example objectives include: installing an application associated with a content item in a campaign, indicating a preference for a content item included in the campaign, sharing a content item included in the advertising campaign, interacting with an object associated with a content item in the advertising campaign, or performing any other suitable interaction. An objective may be associated with individual content items or may be associated with a campaign, which associates the objective with each content item in the campaign. Additionally, content items or campaigns obtained by the online system may include bid amounts, with a bid amount included in a content item specifying an amount of compensation the online system receives from a user providing the content item to the online system in exchange for presenting the content item to another user or in exchange for another user performing the activity specified by the objective of the content item after being presented with the content item.

Additionally, different types of content items are included in the various campaigns. For example, different campaigns include different types of content items, or a campaign includes multiple types of content items. In some embodiments, a type of content item identifies a type of content—audio, video, text, or image data—presented by the content item. Alternatively, a type of content item identifies a type of client device (e.g., mobile device, desktop device) on which the content item is configured to be presented. In other embodiments, a type of content item specifies a context in which the content item is to be presented. A context in which a content item is presented refers to additional content presented in conjunction with the content item or additional content presented prior to or subsequent to presentation of the content item. Example contexts in which a content item is presented include: in a feed including other content items, in an application, in response to the online system receiving an indication the user performed a certain action, in a page of content, in content provided by a third party system, or in any other suitable location relative to other content.

However, when a user provides multiple campaigns to the online system, the user may have difficulty subsequently evaluating performance of content items included in different campaigns. For example, for the user to evaluate effectiveness of various campaigns in achieving a particular objective, conventional methods involve the user accessing and evaluating different campaigns, which may be time consuming. To simplify evaluation of content items in various campaigns, the online system obtains two or more campaigns provided by the user. For example, the online system receives the campaigns from the user or from a third party system, retrieves campaigns stored by the online system, or some combination thereof. The obtained campaigns include at least two objectives associated with different content items in various embodiments.

From the obtained campaigns, the online system generates a plan including one or more groups. Each group includes content items from one or more campaigns associated with a common objective. For example, the online system identifies an objective associated with each content item of the obtained campaigns and generates different groups that each include content items having a common objective. As an example, the plan includes a group having content items associated with an objective of accessing a page of content and another group having content items associated with an objective of accessing the content items themselves. Hence, the plan organizes content items from the obtained campaigns based on objectives associated with content items of the campaigns.

In some embodiments, the online system generates a visual representation of the one or more groups of content items included in the plan and communicates the visual representation to a client device associated with the user. For example, the online system generates a table where content items associated with a common objective are positioned adjacent to each other in the table. As an example, the online system generates a table where adjacent rows include content items associated with an objective of accessing content items and where other adjacent rows include content items associated with an objective of presenting the content items to users. Visual representations of various content items may include any suitable information describing the content items. For example a row in a table representing a content item of a group of the plan includes an identifier of a content item, a time when the content item was received, content included in the content item, targeting criteria included in the content item, or any other suitable characteristics of the content item.

After obtaining the campaigns, the online system extracts characteristics from at least a set of the content item included in the plan and obtains bid amounts for content items of the set from the user based at least in part on the extracted characteristics. This allows the user to more easily provide bid amounts used by the online system when determining whether to present various content items by determining various other characteristics of the content items rather than requesting the other characteristics of the content items form the user along with the bid amounts. For example, the online system includes various characteristics extracted from a content item of the set in a form prompting the user to specify a bid amount for the content item and communicates the form to a client device associated with the user. In an example, the online system extracts an identifier of the content item and content included in the content item and populates fields in the form with the extracted identifier and content. When the user provides the bid amount to the form via the client device the client device communicates the bid amount to the online system, which stores the bid amount in association with the content item. Including the information extracted from the content item in the form allows the user to more easily provide the bid amount to the online system by reducing the information for the user to provide to the online system in association with the bid amount to identify the content item.

In various embodiments, the online system provides the user with multiple forms each including one or more of the characteristics extracted from the content item and configured to receive additional information about the content item from the user. Similarly, the form provided to the user prompting the user for the bid amount for the content item may prompt the user for additional information associated with the content item. For example, the form prompts the user to also specify targeting criteria associated with the content item that identify characteristics of users of the online system eligible to be presented with the content item.

After obtaining bid amounts for the content items of the set, the online system includes one or more content items of the set and their corresponding bid amounts in one or more selection processes performed by the online system to select content for presentation to additional users of the online system. For example, when the online system identifies an opportunity to present content to an additional user of the online system, the online system includes one or more content items of the set, and their corresponding bid amounts, in one or more selection processes that select content for presentation to the additional user. The online system may determine expected values to the online system of presenting various content items to an additional user, with an expected value of presenting a content item based on a likelihood of the additional user performing an objective associated with the content item after being presented with the content item and the bid amount associated with the content item. The online system ranks the content items based on their expected values and selects content items having at least a threshold position in the ranking for presentation to the additional user.

While one or more content items of the set are included in one or more selection processes, the online system obtains information describing presentation of the content items of the set to the one or more additional users. In various embodiments, the online system obtains an amount of compensation received by the online system from the user in exchange for presenting one or more content items of the set. Additionally or alternatively, the online system may obtain a number of times various content items of the set were selected for presentation to additional users, a number of times objectives associated with content items of the set were performed by additional users to whom one or more content items of the set were presented, or any other suitable information. For example, the online system receives information from client devices associated with users to whom one or more content items from the set were presented identifying one or more actions performed by the additional users after being presented with the one or more content items. From the received information, the online system determines whether an action performed by an additional user presented with a content item matches an objective associated with the content item and stores information indicating the objective was performed if the action performed by the additional user presented with the content item matches the objective associated with the content item.

Based on the obtained information, the online system generates one or more metrics describing presentation of various content items of the set to the additional users. Metrics may be generated for individual content items, for various groups of content items associated with a common objective, or for different campaigns included in the plan. Because the set includes content items from the plan, the generated metrics describe presentation of content items included in the plan. The online system may generates various metrics in different embodiments. For example, the online system combines amounts received from the user in exchange for presenting various content items to generate an amount spent by the user for presenting various content items included in the plan. As another example, the online system determines a ratio of a number of times the objective associated with a content item was performed to a number of times the content item was presented to users. The online system may determine a number of times a content item included in the plan was presented to users. In other embodiments, the online system generates a number of unique users to whom a content item included in the plan was presented.

The online system transmits the one or more metrics to the client device associated with the user, allowing the user to evaluate presentation of content items of the plan to various other users by the online system. In some embodiments, the online system modifies the visual representation of the one or more groups of content items included in the plan to include the generated metrics. For example, the online system augments a visual representation of a content item with a generated metric or augments a visual representation of a group of content items with a metric generated for the group.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment of.

FIG. 3 is a flowchart of a method for evaluating a plan for presentation of content via an online system including multiple content items having different objectives, in accordance with an embodiment.

FIG. 4 is an example visual representation of a plan including content items associated with different objectives, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

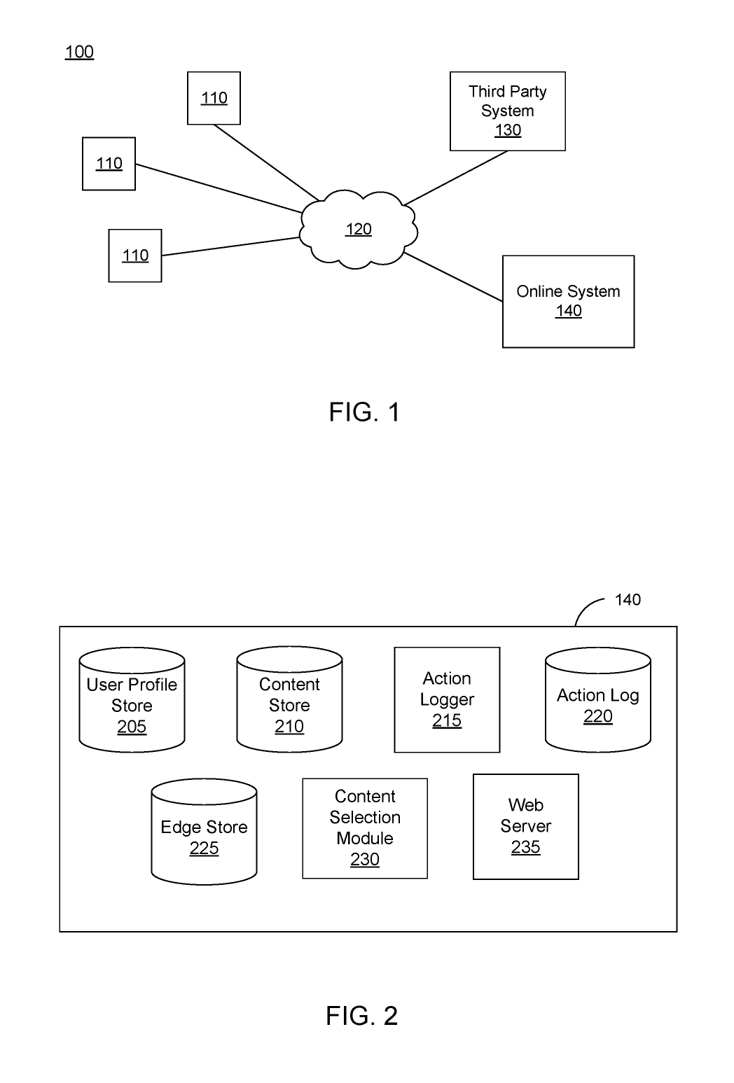

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 130 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store 210 for subsequent retrieval by the content selection module 230, which is further described below.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

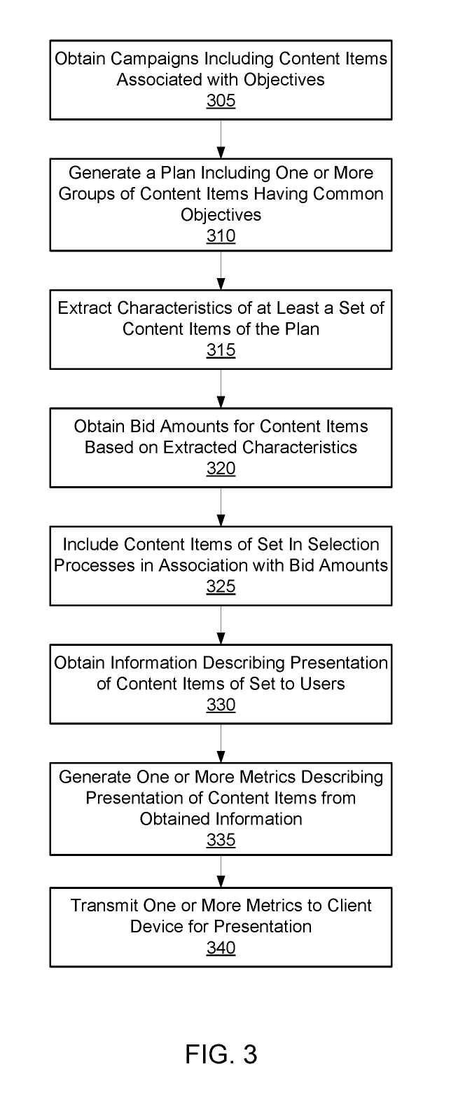

As further described below in conjunction with FIG. 3, the content selection module 230 obtains content items from various campaigns associated with a user and generates groups of content items each having a common objective from content items of different campaigns. For example, a group includes content items having a common objective and from two or more campaigns. The content selection module 230 generates a plan including the generated groups, allowing content items of different campaigns to be accessible by interacting with the plan. The content selection module 230 may generate a visual representation of the plan that is communicated to a client device 110 associated with the user providing the campaigns to the online system 140 (or who is otherwise associated with the campaigns). Communicating the visual representation of the plan to the client device 110 allows the user to view content items of various campaigns that have a common objective, allowing the user to more easily identify content items having a common objective from various campaigns.

Further, to simplify configuration of content items for presentation by the online system 140, the content selection module 230 extracts characteristics from at least a set of the content items included in the plan and obtains bid amounts for content items of the set based at least in part on the extracted characteristics. As further described below in conjunction with FIG. 3, the online system 140 includes characteristics extracted from a content item in a form that prompts the user to provide a bid amount for the content item, reducing information that the user provides to the online system 140 to specify the bid amount for the content item. After receiving the bid amounts for content items of the plan, the content selection module 230 includes the content items in one or more selection processes, as further described above. As content items of the plan are selected by the one or more selection processes and presented to other users of the online system 140, the content selection module 230 obtains information describing presentation of the content items of the plan. Based on the information describing presentation of content items of the plan, the content selection module 230 generates one or more metrics for the content items, for groups of content items of the plan, or of the plan and provides the generated metrics to the client device 110 associated with the user, allowing the user to more easily evaluate performance of presenting various content items of the plan to users of the online system 140, as further described above in conjunction with FIG. 3.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

Evaluating Presentation of Content Items Presented from Various Campaigns

FIG. 3 is a flowchart of one embodiment of a method for evaluating a plan for presentation of content via an online system 140 including multiple content items having different objectives. In other embodiments, the method may include different and/or additional steps than those shown in FIG. 3. Additionally, steps of the method may be performed in different orders than the order described in conjunction with FIG. 3 in various embodiments.

An online system 140 obtains 305 various campaigns including one or more content items from a user. The online system 140 may obtain 305 the campaigns by receiving the campaigns from a user or from a third party system 130. Alternatively, the online system 140 obtains 305 the campaigns by retrieving one or more campaigns previously received from the user and stored by the online system 140 (e.g., stored in the content store 210 of the online system 140). In other embodiments, the online system 140 may obtain 305 a set of campaigns from a third party system 130, receive additional campaigns from the user, and retrieve other campaigns previously received and stored by the online system 140. Hence, the campaigns may be obtained 305 from any suitable source or combination of sources in various embodiments.

Different content items are associated with an objective, which specifies an interaction the user associated with the content item desires users to perform when presented with the content item. The obtained campaigns include at least two objectives associated with different content items in various embodiments. An objective may be associated with individual content items or may be associated with a campaign, which associates the objective with each content item in the campaign. Example objectives include: installing an application associated with a content item in a campaign, indicating a preference for a content item included in the campaign, sharing a content item included in the advertising campaign, interacting with an object associated with a content item in the advertising campaign, or performing any other suitable interaction. As further described above in conjunction with FIG. 2, various content items include bid amounts specifying amounts of compensation the online system 140 receives from the user in exchange for presenting the content items to users or in exchange for users performing one or more specific actions after being presented with the content items.

Additionally, different types of content items are included in the obtained campaigns. For example, different campaigns include different types of content items, or a campaign includes multiple types of content items. In some embodiments, a type of content item identifies a type of content—audio, video, text, or image data—presented by the content item. Alternatively, a type of content item identifies a type of client device 110 (e.g., mobile device, desktop device) on which the content item is configured to be presented. In other embodiments, a type of content item specifies a context in which the content item is to be presented. A context in which a content item is presented refers to additional content presented in conjunction with the content item or additional content presented prior to or subsequent to presentation of the content item. Example contexts in which a content item is presented include: in a feed including other content items, in an application, in response to the online system 140 receiving an indication the user performed a certain action, in a page of content, in content provided by a third party system 130, or in any other suitable location relative to other content.

However, when a user provides multiple campaigns to the online system 140, the user may have difficulty subsequently evaluating performance of content items included in different campaigns. For example, for the user to evaluate effectiveness of various campaigns in achieving a particular objective, conventional methods involve the user accessing and evaluating different campaigns, which may be time consuming. From the obtained campaigns, the online system 140 generates 310 a plan including one or more groups. Each group includes content items from one or more campaigns associated with a common objective. For example, the online system 140 identifies an objective associated with each content item of the obtained campaigns and generates different groups that each include content items having a common objective. Hence, the plan organizes content items from the obtained campaigns based on objectives associated with content items of the campaigns.

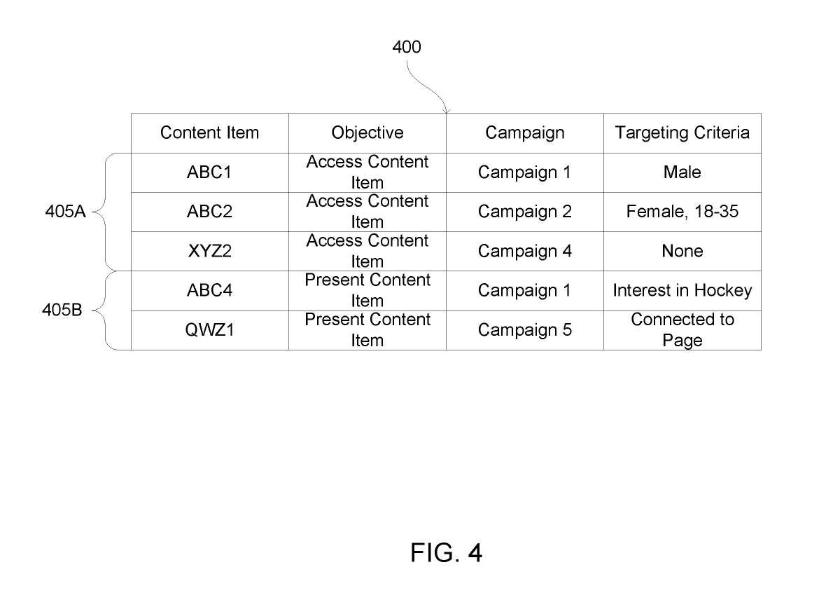

In some embodiments, the online system 140 generates a visual representation of the one or more groups of content items included in the plan and communicates the visual representation to a client device 110 associated with the user. FIG. 4 shows an example visual representation of the one or more groups of content items. In the example of FIG. 4, the online system 140 generates a table 400 where content items associated with a common objective are positioned in rows 405 adjacent to each other in the table 400. For example, adjacent rows 405A in the table 400 include content items associated with an objective 410 of accessing content items and where other adjacent rows 405B include content items associated with an alternative objective 415 of presenting the content items to users. Visual representations of various content items may include any suitable information describing the content items. For example a row 405 in the table 400 representing a content item in a group of the plan includes an identifier of a content item, an identifier of a campaign that includes the content item, targeting criteria included in the content item, or any other suitable characteristics of the content item.

Referring back to FIG. 3, after obtaining 310 the campaigns, the online system 140 simplifies acquisition of characteristics for presenting the content items from the user by extracting 315 characteristics from at least a set of the content items included in the plan and obtaining 320 bid amounts for content items of the set based at least in part on the extracted characteristics. For example, the online system 140 extracts 315 characteristics from each of the content items of the plan. This allows the user to more easily provide bid amounts used by the online system 140 when determining whether to present various content items by determining various other characteristics of the content items rather than requesting the other characteristics of the content items form the user along with the bid amounts. For example, the online system 140 includes various characteristics extracted from a content item of the set in a form prompting the user to specify a bid amount for the content item and communicates the form to a client device 110 associated with the user. In an example, the online system 140 extracts an identifier of the content item and content included in the content item and populates fields in the form with the extracted identifier and content. When the user provides the bid amount to the form via the client device 110, the client device 110 communicates the form, including the bid amount, to the online system 140, which stores the bid amount from the form in association with the content item. Including the information extracted from the content item in the form allows the user to more easily provide the bid amount to the online system 140 by reducing the information for the user to provide to the online system 140 in association with the bid amount to identify the content item.

In various embodiments, the online system 140 provides the user with multiple forms each including one or more of the characteristics extracted from the content item and configured to receive additional information about the content item from the user. Similarly, the form provided to the user prompting the user for the bid amount for the content item may prompt the user for additional information associated with the content item. For example, the form prompts the user to also specify targeting criteria associated with the content item that identify characteristics of users of the online system 140 eligible to be presented with the content item. In other embodiments, the form, or another form including characteristics extracted from the content item, prompts the user to provide any suitable information that the online system 140 may use when selecting content for presentation to various users of the online system 140.

After obtaining 320 the bid amounts for the content items of the set, the online system 140 includes 325 one or more content items of the set and their corresponding bid amounts in one or more selection processes performed by the online system 140 to select content for presentation to additional users of the online system 140. For example, when the online system 140 identifies an opportunity to present content to an additional user of the online system 140, the online system 140 includes one or more content items of the set, and their corresponding bid amounts, in one or more selection processes that select content for presentation to the additional user. In some embodiments, as further described above in conjunction with FIG. 2, the online system 140 determines expected values to the online system 140 of presenting various content items to an additional user, with an expected value of presenting a content item based on a likelihood of the additional user performing an objective associated with the content item after being presented with the content item and the bid amount associated with the content item. The online system 140 ranks the content items based on their expected values and selects content items having at least a threshold position in the ranking for presentation to the additional user.

While one or more content items of the set are included 325 in one or more selection processes, the online system 140 obtains 330 information describing presentation of the content items of the set to the one or more additional users. In various embodiments, the online system 140 obtains 330 an amount of compensation received by the online system 140 from the user in exchange for presenting one or more content items of the set. Additionally or alternatively, the online system 140 may obtain 330 a number of times various content items of the set were selected for presentation to additional users, a number of times objectives associated with content items of the set were performed by additional users to whom one or more content items of the set were presented, or any other suitable information. For example, the online system 140 receives information from client devices 110 associated with users to whom one or more content items from the set were presented identifying one or more actions performed by the additional users after being presented with the one or more content items. From the received information, the online system 140 determines whether an action performed by an additional user presented with a content item of the set within a threshold amount of time after being presented with the content item matches an objective associated with the content item. If an action performed by the additional user presented with the content item within the threshold amount of time after being presented with the content item matches the objective associated with the content item, the online system 140 stores information associated with the content item indicating the objective was performed.

Based on the obtained information, the online system 140 generates 335 one or more metrics describing presentation of various content items of the set to the additional users. Metrics may be generated 335 for individual content items, for various groups of content items associated with a common objective, or for different campaigns included in the plan. Because the set includes content items from the plan, the generated metrics describe presentation of content items included in the plan. The online system 140 may generate 335 various metrics in different embodiments. For example, the online system 140 combines amounts received from the user in exchange for presenting various content items to generate 335 an amount spent by the user for presenting various content items included in the plan. As another example, the online system 140 determines a ratio of a number of times the objective associated with a content item was performed to a number of times the content item was presented to users. The online system 140 may determine a number of times a content item included in the plan was presented to users. In other embodiments, the online system 140 generates 335 a number of unique users to whom a content item included in the plan was presented.

In some embodiments, the online system 140 determines a budget for presenting content items of the plan to additional users of the online system 140 from the obtained bid amounts or from other information received from the user. For example, the online system 140 determines a budget for presenting content items of a group associated with a common objective based on the obtained bid information or from other information received from the user. Based on an amount spent by the user for presenting various content items included in the group and obtained information describing presentation of content items included in the group to additional users, the online system 140 estimates an amount to be received by the online system 140 from the user in exchange for presenting content items of the group. For example, the online system 140 determines an estimated amount to be received from the user based on an amount received by the online system 140 for presenting content items of the group, a duration content items from the group have been included 325 in one or more selection processes, and a number of times content items of the group have been presented to online system users. The online system 140 compares the budget to the estimated amount to be received and communicates a notification to increase the budget to the client device 110 associated with the user if the estimated amount to be received exceeds the budget in some embodiments. This allows the online system 140 to prompt the user to increase the budget for presenting content items in the group based on an amount the user has currently spent for presenting content items in the group to allow the user to better present content items of the group to other users.

The online system 140 transmits 340 the one or more metrics to the client device 110 associated with the user, allowing the user to evaluate presentation of content items of the plan to various other users by the online system 140. In some embodiments, the online system 140 modifies the visual representation of the one or more groups of content items included in the plan to include the generated metrics. For example, the online system 140 augments a visual representation of a content item with a generated metric or augments a visual representation of a group of content items with a metric generated for the group.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
obtaining a plurality of campaigns from a user at an online system, each campaign including one or more content items associated with one or more objectives;
generating a plan including one or more groups of content items of the plurality of campaigns, each group including one or more content items associated with a common objective;
extracting characteristics from at least a set of the content items included in the plan;
obtaining bid amounts for each of the set of the content items based in part on the extracted characteristics;
including one or more content items of the set of the content items with a corresponding bid amount in one or more selection processes performed by the online system to select content for presentation to one or more additional users of the online system;
obtaining information describing presentation of the one or more content items of the set to the one or more additional users by the online system;
generating one or more metrics describing presentation of content items included in the plan based on the obtained information; and
transmitting the one or more metrics to a client device associated with the user.

2. The method of claim 1, further comprising:
generating a visual representation of the one or more groups of content items, the visual representation of a group of content item identifying one or more characteristics of one or more content items included in the group; and
communicating the visual representation to the client device associated with the user for presentation to the user.

3. The method of claim 1, wherein generating one or more metrics describing presentation of content items included in the plan based on the obtained information comprises:
generating a metric associated with each of the one or more objectives based on information describing presentation of one or more content items of the set associated with each of the one or more objectives.

4. The method of claim 1, wherein generating one or more metrics describing presentation of content items included in the plan based on the obtained information comprises:
generating a metric associated with an objective based on information describing presentation of one or more content items of the set associated with the objective.

5. The method of claim 1, wherein obtaining bid amounts for each of the set of the content items based in part on the extracted characteristics comprises:
communicating a form including at least a set of characteristics extracted from a content item of the set of content items to the client device associated with the user, the form prompting the user to specify a bid amount for the content item of the set of content items; and
receiving the form including the bid amount from the client device.

6. The method of claim 5, wherein the form further prompts the user to specify targeting criteria identifying characteristics of users eligible to be presented with the content item of the set of content items.

7. The method of claim 1, wherein obtaining the plurality of campaigns from the user at the online system comprises:
retrieving a plurality of campaigns previously received by the online system from the user and stored by the online system.

8. The method of claim 1, wherein obtaining bid amounts for each of the set of the content items based in part on the extracted characteristics comprises:
determining a budget for presenting a group of content items included in the plan.

9. The method of claim 8, wherein a metric comprises an amount received by the online system in exchange for prior presentation of content items of the group of content items.

10. The method of claim 9, further comprising:
determining an estimated amount to be received by the online system in exchange for presenting content items of the group of content items based on the amount received and information describing presentation of content items of the group of content items;
comparing the budget for presenting content items of the group of content items to the estimated amount to be received by the online system in exchange for presenting content items of the group; and
communicating a notification to increase the budget to the client device associated with the user in response to the comparison determining the budget for presenting content items of the group of content items is less than the estimated amount to be received by the online system in exchange for presenting content items of the group.

11. A computer program product comprising a computer readable storage medium having instructions encoded thereon that, when executed by a processor, cause the processor to:
obtain a plurality of campaigns from a user at an online system, each campaign including one or more content items associated with one or more objectives;
generate a plan including one or more groups of content items of the plurality of campaigns, each group including one or more content items associated with a common objective;
extract characteristics from at least a set of the content items included in the plan;
obtain bid amounts for each of the set of the content items based in part on the extracted characteristics;
include one or more content items of the set of the content items with a corresponding bid amount in one or more selection processes performed by the online system to select content for presentation to one or more additional users of the online system;
obtain information describing presentation of the one or more content items of the set to the one or more additional users by the online system;
generate one or more metrics describing presentation of content items included in the plan based on the obtained information; and
transmit the one or more metrics to a client device associated with the user.

12. The computer program product of claim 11, wherein the computer program product further has instructions encoded thereon that, when executed by the processor, cause the processor to:
generate a visual representation of the one or more groups of content items, the visual representation of a group of content item identifying one or more characteristics of one or more content items included in the group; and
communicate the visual representation to the client device associated with the user for presentation to the user.

13. The computer program product of claim 11, wherein generate one or more metrics describing presentation of content items included in the plan based on the obtained information comprises:
generate a metric associated with each of the one or more objectives based on information describing presentation of one or more content items of the set associated with each of the one or more objectives.

14. The computer program product of claim 11, wherein generate one or more metrics describing presentation of content items included in the plan based on the obtained information comprises:
generate a metric associated with an objective based on information describing presentation of one or more content items of the set associated with the objective.

15. The computer program product of claim 11, wherein obtain bid amounts for each of the set of the content items based in part on the extracted characteristics comprises:
communicate a form including at least a set of characteristics extracted from a content item of the set of content items to the client device associated with the user, the form prompting the user to specify a bid amount for the content item of the set of content items; and
receive the form including the bid amount from the client device.

16. The computer program product of claim 15, wherein the form further prompts the user to specify targeting criteria identifying characteristics of users eligible to be presented with the content item of the set of content items.

17. The computer program product of claim 11, wherein obtain the plurality of campaigns from the user at the online system comprises:
retrieve a plurality of campaigns previously received by the online system from the user and stored by the online system.

18. The computer program product of claim 11, wherein obtain bid amounts for each of the set of the content items based in part on the extracted characteristics comprises:
determine a budget for presenting a group of content items included in the plan.

19. The computer program product of claim 18, wherein a metric comprises an amount received by the online system in exchange for prior presentation of content items of the group of content items.

20. The computer program product of claim 19, wherein the computer program product further has instructions encoded thereon that, when executed by the processor, cause the processor to:
determine an estimated amount to be received by the online system in exchange for presenting content items of the group of content items based on the amount received and information describing presentation of content items of the group of content items;
compare the budget for presenting content items of the group of content items to the estimated amount to be received by the online system in exchange for presenting content items of the group; and
communicate a notification to increase the budget to the client device associated with the user in response to the comparison determining the budget for presenting content items of the group of content items is less than the estimated amount to be received by the online system in exchange for presenting content items of the group.
